(19) United States
(12) Patent Application Publication
(10) Pub. No.: US 2022/0099236 A1
(43) Pub. Date: Mar. 31, 2022

(54) METHOD OF MANUFACTURING VACUUM HEAT INSULATOR AND VACUUM HEAT INSULATOR

(71) Applicant: Yazaki Energy System Corporation, Tokyo (JP)

(72) Inventor: Takuju NAKAMURA, Hamamatsu-shi (JP)

(73) Assignee: Yazaki Energy System Corporation, Tokyo (JP)

(21) Appl. No.: 17/545,308

(22) Filed: Dec. 8, 2021

Related U.S. Application Data
(63) Continuation of application No. PCT/JP2020/019696, filed on May 18, 2020.

(30) Foreign Application Priority Data
Jun. 19, 2019 (JP) 2019-113617

(51) Int. Cl. F16L 59/065; B29C 44/18; B29C 44/56; B29C 44/12

(52) U.S. Cl. CPC F16L 59/065; B29C 44/18; B29C 44/5609; B29K 2995/0015; B29C 44/1266; B29K 2995/0016; B29C 44/128

(57) ABSTRACT

A method of manufacturing a vacuum heat insulator includes preparing a hollow body that has heat resistance equal to or higher than a level to withstand a flame of 781° C. for 20 minutes and that has a hollow portion in the hollow body, introducing, into the hollow portion of the hollow body, an inorganic foaming agent that has the heat resistance and foaming the foaming agent to form a foam having open cells, or introducing an inorganic foam having the heat resistance and open cells, and then solidifying the foam, and evacuating the hollow portion after the foam is solidified or during the solidification of the foam.

### CROSS-REFERENCE TO RELATED APPLICATIONS

This is a continuation of International Application No. PCT/JP2020/019696 filed on May 18, 2020, and claims priority from Japanese Patent Application No. 2019-113617 filed on Jun. 19, 2019, the entire content of which is incorporated herein by reference.

### TECHNICAL FIELD

The present invention relates to a method of manufacturing a vacuum heat insulator, and a vacuum heat insulator.

### BACKGROUND ART

In the related art, there is known a vacuum heat insulation panel for construction in which a glass fiber is used as a core material and the core material is packed with a resin film including an aluminum layer (see, for example, JP-A-58-127085). The vacuum heat insulation panel is obtained by diverting a technique for a refrigerator, and a shape of the vacuum heat insulation panel is not specified (the vacuum heat insulation panel does not have shape stability), and the vacuum heat insulation panel does not have fire resistance. Further, since the resin film allows nitrogen and hydrogen in the atmosphere to pass through the resin film, the degree of vacuum is lowered, and there is a problem in terms of a heat insulation property.

In addition, there is known a vacuum heat insulation panel in which a glass fiber is used as a core material and is packed with a thin stainless steel plate (see, for example, JP-A-2010-281387). Although this vacuum heat insulation panel can maintain vacuum and ensure a heat insulation property by using the thin stainless steel plate, shape stability is insufficient and fire resistance is insufficient since the core material is a glass fiber (shrinkage at 400° C. or more).

On the other hand, there is proposed a case in which an LNG tank has a double structure including an inner tank and an outer tank that covers the inner tank, and pearlite powder is filled as a core material between the inner and outer tanks of the LNG tank (see, for example, JP-A-2-256999). This tank has fire resistance and shape stability because the tank has a double structure, and can improve a heat insulation property.

However, when the tank described in JP-A-2-256999 is applied to the vacuum heat insulation panels described in JP-A-58-127085 and JP-A-2010-281387, it is difficult to adopt a thick structure such as a tank wall, and fire resistance, shape stability, and a heat insulation property cannot be ensured. In particular, in JP-A-2-256999, the pearlite powder is not solidified and remains in a powder state. Therefore, when the pearlite powder is used as the core material in the vacuum heat insulation panel, the pearlite powder collapses, and it cannot say that such a vacuum heat insulation panel has shape stability.

The above explanation is not limited to a vacuum heat insulation panel, and is also common to a vacuum heat insulator that does not have a panel shape and has a size or the like similar to a size of the vacuum heat insulation panel.

### SUMMARY OF INVENTION

Aspect of non-limiting embodiments of the present disclosure relates to provide a method of manufacturing a vacuum heat insulator and a vacuum heat insulator that can ensure fire resistance, shape stability, and a heat insulation property.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided a method of manufacturing a vacuum heat insulator including preparing a hollow body that has heat resistance equal to or higher than a level to withstand a flame of 781° C. for 20 minutes and that has a hollow portion in the hollow body, introducing, into the hollow portion of the hollow body prepared in the first step, an inorganic foaming agent that has the heat resistance and foaming the foaming agent to form a foam having open cells, or introducing an inorganic foam having the heat resistance and open cells, and then solidifying the foam, and evacuating the hollow portion after the foam is solidified or during the solidification of the foam.

The manufacturing method includes a case where both the foaming agent and the foam are introduced. Therefore, the manufacturing method includes a case of introducing a foaming agent of which a part is pre-foamed (that is, a part of the foaming agent is a foam) and the remaining part of the foaming agent is foamed in the hollow portion to form a foam having open cells. Furthermore, the manufacturing method includes a case where, when two different foaming agents are introduced, one foaming agent was foamed and the other foaming agent is foamed in the hollow portion.

According to another aspect of the present disclosure, there is provided a vacuum heat insulator including a hollow body that has heat resistance equal to or higher than a level to withstand a flame of 781° C. for 20 minutes and that has a hollow portion formed in the hollow body, and an inorganic foam that spreads in the hollow portion of the hollow body, is formed with open cells, is foamed and solidified, and has the heat resistance, in which the hollow portion is evacuated.

### BRIEF DESCRIPTION OF DRAWINGS

Exemplary embodiment(s) of the present invention will be described in detail based on the following figures, wherein:

FIG. 1 is a cross-sectional view showing an example of a vacuum heat insulator according to a first embodiment of the present invention.

FIGS. 2A to 2E are step diagrams showing a method of manufacturing a vacuum heat insulation panel according to the first embodiment, FIG. 2A shows a preparation step, FIG. 2B shows a hollow body manufacturing step, FIG. 2C shows a foaming agent introducing step, FIG. 2D shows a vacuum solidification step, and FIG. 2E shows a coating step.

FIG. 3 is a cross-sectional view showing an example of a vacuum heat insulation panel according to a second embodiment.

FIGS. 4A to 4D are step diagrams showing a method of manufacturing the vacuum heat insulation panel according to the second embodiment, FIG. 4A shows a preparation step, FIG. 4B shows a hollow body manufacturing step, FIG. 4C shows a foaming agent introducing step, and FIG. 4D shows a vacuum solidification step.

### DESCRIPTION OF EMBODIMENTS

Hereinafter, the present invention will be described in accordance with preferred embodiments. The present invention is not limited to the following embodiments, and can be modified as appropriate without departing from the scope of the present invention.

In the embodiments described below, some configurations are not illustrated or described, but it goes without saying that a known or well-known technique is applied as appropriate to details of an omitted technique within a range in which no contradiction occurs to contents described below.

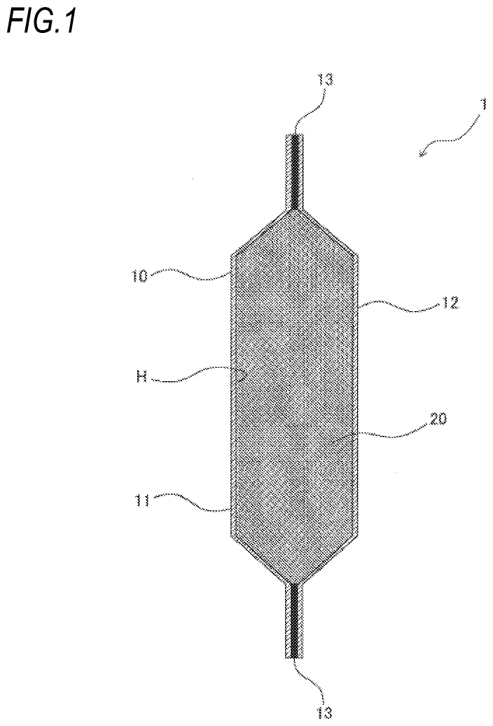

FIG. 1 is a cross-sectional view showing an example of a vacuum heat insulator according to a first embodiment of the present invention. Although a vacuum heat insulation panel having a panel shape is described as an example of the vacuum heat insulator in FIG. 1, the vacuum heat insulator is not limited to a heat insulator having a panel shape, and may have other shapes such as a cylindrical shape.

A vacuum heat insulation panel (vacuum heat insulator) 1 according to the example shown in FIG. 1 includes a hollow body 10 and an inorganic foam 20.

The hollow body 10 is formed by processing a plurality of (two) metal plates 11 and 12 to form a hollow portion H in the hollow body 10. Each of the metal plates 11 and 12 is processed to form a recessed portion. The metal plates 11 and 12 are combined in a manner in which the recessed portions of the metal plates 11 and 12 are aligned with each other and the metal plates 11 and 12 are integrated (outer periphery sealing) with each other via a joining portion 13 at portions other than the recessed portions, thereby forming the hollow portion H in the hollow body 10. The joining portion 13 is formed by seam welding or diffusion joining.

Here, the metal plates 11 and 12 have heat resistance equal to or higher than heat resistance to withstand a flame of 781° C. for 20 minutes, preferably the metal plates 11 and 12 have heat resistance to withstand a flame of 843° C. for 30 minutes or more, and more preferably the metal plates 11 and 12 have heat resistance to withstand a flame of 902° C. for 45 minutes or more (heat resistance that does not dissolve). The metal plates 11 and 12 are made of, for example, stainless steel. The metal plates 11 and 12 have a plate thickness of 0.1 mm or more and 2.0 mm or less, and preferably 0.1 mm or more and 0.5 mm or less. Here, when the vacuum heat insulation panel 1 is used for construction, it is considered that the vacuum heat insulation panel 1 needs to have a thickness of at least 0.1 mm in consideration of a piercing strength required for safety at the time of performing a work or at the time of being used. In addition, it is considered that the vacuum heat insulation panel 1 needs to have a thickness of 2.0 mm or less, and more preferably 0.5 mm or less from the viewpoint of being used as a building material and a building load bearing limitation.

The foam 20 is formed with open cells, and is foamed and solidified. The foam 20 is made of an inorganic material, and has a thickness of, for example, about several centimeters or more in the present embodiment. Similar to the hollow body 10, the foam 20 has heat resistance equal to or higher than heat resistance to withstand a flame of 781° C. for 20 minutes, preferably the foam 20 has heat resistance to withstand a flame of 843° C. for 30 minutes or more, and more preferably the foam has heat resistance to withstand a flame of 902° C. for 45 minutes or more. The term “heat resistance” refers to heat resistance that does not cause combustion shrinkage and does not generate outgas. The foam 20 is made of, for example, foamed glass, pearlite powder, vermiculite, fumed silica, diatomaceous earth, calcium silicate, or the like. It is preferable that the foam 20 is foamed in the hollow portion H and spreads to every corner of the hollow portion H. In addition, the foam 20 may be solidified by a method such as pressing, and the foam 20 may spread to every corner of the hollow portion H by pressing.

When the vacuum heat insulation panel 1 is used for construction (for example, a required lifetime of about 50 years), it is preferable that the foam 20 does not decompose and deteriorate for 50 years and does not generate outgas. The foam 20 having a specific gravity of 0.7 or less, preferably 0.5 or less, and more preferably 0.2 or less is used for construction from the viewpoint of a weight limitation.

Further, the hollow portion H of the vacuum heat insulation panel 1 according to the first embodiment is evacuated. Here, since the foam 20 in the hollow portion H is formed with open cells, inner sides of the open cells are vacuumed by evacuating to exhibit a heat insulation property.

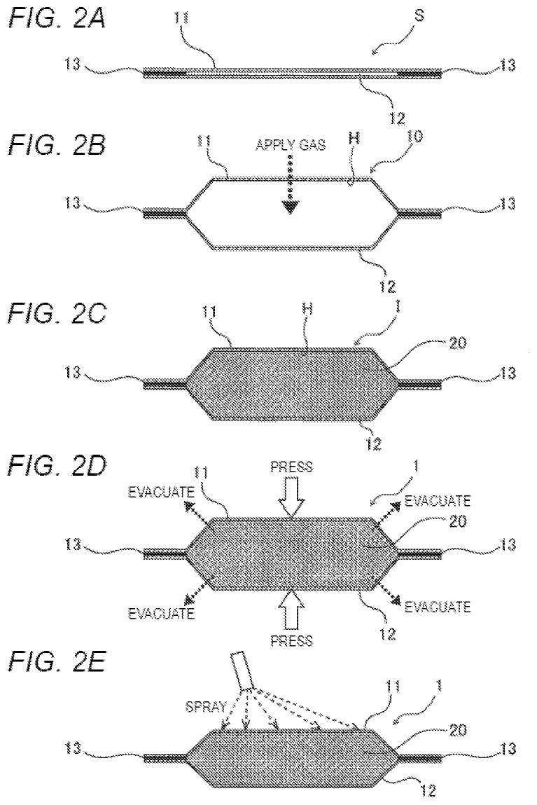

FIGS. 2A to 2E are step diagrams showing a method of manufacturing the vacuum heat insulation panel 1 according to the first embodiment, FIG. 2A shows a preparation step, FIG. 2B shows a hollow body manufacturing step, FIG. 2C shows a foaming agent introducing step, FIG. 2D shows a vacuum solidification step, and FIG. 2E shows a coating step.

First, in the preparation step shown in FIG. 2A, the metal plates 11 and 12 that are made of stainless steel or the like and have a plate thickness of 0.1 mm or more and 2.0 mm or less are prepared, and the joining portion 13 is formed by seam welding or diffusion joining. Accordingly, a flat plate shaped stacked body S in which the metal plates 11 and 12 are integrated with each other via the joining portion 13 is obtained.

In the subsequent hollow body manufacturing step, the flat plate shaped stacked body S is put into a die (not shown). An inner side of the die is heated to a high temperature environment (for example, 800° C. or more and 1000° C. or less) in which temperature is in the vicinity of a foaming temperature of a foaming agent (particularly in a case where the foaming agent is a mixture of two or more components, temperature is close to a foaming temperature of at least one component) for obtaining the foam 20 shown in FIG. 1 and the temperature is lower than a melting point of the metal plates 11 and 12. Here, the vicinity of a foaming temperature refers to a temperature equal to or higher than a temperature that is lower than the foaming temperature by 200° C. Under such a high temperature environment, argon gas or the like is fed into a space (gap) between the metal plates 11 and 12. An internal space between the metal plates 11 and 12 are expanded by applying such a gas pressure, and the hollow body 10 having the hollow portion H shown in FIG. 2B is obtained (first step). The die has such a die structure that the hollow body 10 having the shape shown in FIG. 2B can be obtained. In addition, the gas pressure may be applied by continuously feeding a gas such as argon, or may be applied by sealing the hollow portion H after feeding a predetermined amount of a gas such as argon.

Next, in the foaming agent introducing step, a foaming agent having the heat resistance (including partially foamed foaming agent) is introduced into the hollow portion H under the high temperature environment described above (second step). An appropriate foaming agent is selected, and after the foaming agent is introduced into the hollow portion H, the foaming agent is foamed to form open cells in the high temperature environment so as to form the foam 20 (in the case where the foaming agent is partially foamed, a remaining part is foamed to form open cells in the high temperature environment so as to form the foam 20 as a whole). The foam 20 is foamed in the hollow portion H and spreads to every corner of the hollow portion H. As a result, an intermediate I shown in FIG. 2C is manufactured. In the foaming agent introducing step, when temperature in the die does not reach a foaming temperature of the foaming agent, the temperature is increased to the foaming temperature. Further, when the foaming agent is to be introduced, it is preferable that the hollow portion H is evacuated and the foaming agent is drawn into the hollow portion H using a vacuum state. This is because the foaming agent can be easily introduced into every corner of the hollow portion H. In addition, the foamed foam 20 formed with open cells may be introduced instead of the foaming agent.

Next, in the vacuum solidification step shown in FIG. 2D, for example, pressing is performed from outer sides of the metal plates 11 and 12 so as to compress the foam 20 (second step). After the pressing is sufficiently performed and the foam 20 is solidified, evacuation is performed to evacuate inner sides of the open cells (third step).

The evacuation is performed by using, for example, a gas introduction hole (not shown) used for feeding a gas in an intermediate manufacturing step shown in FIG. 2B or a foaming agent introduction hole (not shown) used for introducing a foaming agent in the foaming agent introducing step shown in FIG. 2C. In addition, after the evacuation, a gas sealing hole (evacuation hole) and the like is sealed by an appropriate method.

Next, in the coating step shown in FIG. 2E, glaze powder (surface treatment material to be fused at a melting temperature equal to or higher than the heat resistant temperature) for enamel application is sprayed onto at least a part of outer surfaces of the metal plates 11 and 12 in a high temperature state. The glaze is melted at about 900° C. (melting temperature) and fused to the outer surfaces of the metal plates 11 and 12, and then the glaze is cooled to form a strong heat resistant coating film. Therefore, in the coating step, after the foam 20 is solidified, the glaze is sprayed in a state in which temperatures of the outer surfaces of the metal plates 11 and 12 are 900° C. or more and the glaze is fused (fourth step). Accordingly, it is possible to save time and effort of putting both of the metal plates 11 and 12 in a furnace and reheating the metal plates 11 and 12 after spraying or the like is performed on the cooled metal plates 11 and 12.

Although the evacuation is performed after the foam 20 is solidified as described above, the evacuation is preferably performed during the solidification of the foam 20. For example, when an external force is applied to solidify the foam 20, some of the open cells are divided by the external force and become closed cells. Inner sides of the closed cells cannot be vacuumed by evacuation. Therefore, in a case where evacuation is performed in a state of open cells during the solidification of the foam 20, even when some open cells become closed cells in a later stage, the closed cells can be evacuated and a heat insulation property can be improved.

Further, although the foam 20 is solidified by pressing from the outer sides of the metal plates 11 and 12 as described above, the present invention is not limited thereto, and the foam 20 may be solidified by the following three methods.

The first method is to introduce a mixture of a foaming agent for forming open cells at the time of foaming (for example, pearl powder (powder that becomes pearlite powder after foaming)) and a foaming agent for forming closed cells at the time of foaming (for example, a mixture of a powder glass and a foaming aid) in the foaming agent introducing step. Here, the foaming agent for forming closed cells has higher viscosity at the foaming temperature than the foaming agent for forming open cells. That is, the foaming agent having high viscosity is brought into an adhesive state, and is solidified by being cooled in such a state.

The second method is to introduce, together with the foaming agent, an adhesive that is not foamed at the foaming temperature of the foaming agent and has heat resistance (for example, an inorganic heat resistant adhesive such as Aron Ceramic (registered trademark) manufactured by Toagosei Co., Ltd.) in the foaming agent introducing step. That is, the foam 20 is solidified by using an adhesive force of the adhesive.

The third method is to introduce a thermoplastic material (fusing material) such as a powder glass that is fluidized at a temperature equal to or higher than the heat resistant temperature (a temperature related to the heat resistance) together with the foaming agent for forming open cells at the time of foaming or the foam 20 having open cells in the foaming agent introducing step. In this case, after an unfoamed or partially foamed foaming agent is introduced into the hollow portion H and is brought into a foamed state, or after the fully foamed foam 20 is introduced into the hollow portion H, temperature is further increased to fluidize the thermoplastic material. Then, the thermoplastic material is cooled so as to bond and solidify the foam 20.

In this manner, according to the method of manufacturing the vacuum heat insulation panel 1 according to the first embodiment, the hollow body 10 and the foam body 20 have heat resistance equal to or higher than heat resistance to withstand a flame of 781° C. for 20 minutes, so that the vacuum heat insulation panel 1 having excellent fire resistance can be obtained. A stable shape can be obtained by introducing an inorganic foaming agent into the hollow portion H to foam the foaming agent so as to form the foam 20 and then solidifying the foam 20, or by introducing the foam 20 and solidifying the foam 20. In addition, the foaming agent is foamed to form open cells or the foam 20 having open cells is introduced, and then evacuating is performed, inner sides of the cells can be brought to be a vacuum portion to exhibit a heat insulation property. Therefore, it is possible to provide a method of manufacturing the vacuum heat insulation panel 1 that can ensure fire resistance, shape stability, and a heat insulation property.

Since the hollow body 10 is obtained by processing a plurality of stacked metal plates 11 and 12 having a plate thickness of 0.1 mm or more and 2.0 mm or less, the shape stability can be improved by such a plate thickness.

The plurality of metal plates 11 and 12 are processed in a high temperature environment to prepare (manufacture) the hollow body 10 having the hollow portion H, and the foaming agent is introduced into the hollow portion H in such a high temperature environment. Therefore, the hollow body 10 can be easily prepared by processing the metal plates 11 and 12 in a situation in which elongation at breakage of metal is improved, such as in a high temperature environment. In addition, since the foaming agent is introduced in such a high temperature environment, the foaming agent can be foamed in such a state, which can contribute to smooth manufacturing of the vacuum heat insulation panel 1.

In a case where the plurality of metal plates 11 and 12 are processed in a high temperature environment to prepare (manufacture) the hollow body 10 having the hollow portion H and the foaming agent or the foam 20 and a fusing material that is fluidized at a temperature equal to or higher than the heat resistant temperature are introduced, there are the following advantages. That is, the fusing material is fluidized after being introduced and then the fusing material is cooled, so that the fusing material can serve as a binder to bond the foam 20, and the foam 20 can be cooled and solidified in a state of being bound. Accordingly, shape stability can be improved.

In a case where an external force is applied to the foam 20 to solidify the foam 20, for example, the foam 20 can be solidified by pressing. Accordingly, higher shape stability can be exhibited.

In a case where a mixture of a foaming agent for forming open cells at the time of foaming and a foaming agent for forming closed cells at the time of foaming is introduced, the foaming agent for forming closed cells that has higher viscosity than the foaming agent for forming open cells is also introduced, in addition to the foaming agent for forming open cells that is introduced in order to exhibit a heat insulation property. Therefore, shape stability can be improved by the foaming agent having high viscosity.

In a case where an adhesive that is not foamed and has heat resistance at the foaming temperature of the foaming agent is introduced together with the foaming agent, shape stability can be improved by using an adhesive force of the adhesive.

A surface treatment material that is fused at a fusion temperature equal to or higher than the heat resistance temperature is sprayed onto at least a part of an outer surface of the hollow body 10 that maintains temperature equal to or higher than the fusion temperature after the foam 20 is solidified. Therefore, it is possible to perform a surface treatment such as enamel by performing spraying while the hollow body 10 maintains temperature equal to or higher than the fusion temperature, and it is possible to save time and effort as compared with a case where the surface treatment is performed after the hollow body 10 is cooled. In addition, since a surface treatment material is fused at a temperature equal to or higher than the heat resistant temperature, heat resistant coating can be performed.

In a case where the hollow portion H is evacuated when the foaming agent or the foam 20 is introduced into the hollow portion H, the foaming agent or the foam 20 can be drawn into the hollow portion H by using the vacuum, and the foaming agent or the foam 20 can spread to every corner of the hollow portion H.

According to the vacuum heat insulation panel 1 in the present embodiment, since the hollow body 10 and the foam body 20 have heat resistance equal to or higher than heat resistance to withstand a flame of 781° C. for 20 minutes, the vacuum heat insulation panel 1 having excellent fire resistance can be obtained. Since the foam 20 spreads in the hollow portion H of the hollow body 10 and is solidified, a stable shape can be obtained. In addition, since the foam 20 is formed with open cells and is foamed and the hollow portion H is evacuated, inner sides of the open cells can be used as vacuum portions and a heat insulation property can be exhibited. Therefore, it is possible to provide the vacuum heat insulation panel 1 that can ensure fire resistance, shape stability, and a heat insulation property.

In the first method, a foaming temperature of the foaming agent (for example, a foamed glass of a powder glass and a foaming aid) for forming closed cells may be appropriately adjusted relative to a foaming temperature of the foaming agent (for example, pearl powder) for forming open cells. For example, it is possible to simplify a process by adjusting the foaming temperature depending on a type of the glass, selection of the foaming aid, a mixing ratio, or the like, or it is possible to break the closed cells of the glass by foaming the pearl powder after foaming the foamed glass first by lowering the foaming temperature.

In the third method, a fluidizing temperature of the thermoplastic material (fusing material) may be appropriately adjusted relative to the foaming temperature of the foaming agent for forming open cells. For example, it is possible to simplify a process by making the foaming temperature equal to the fluidizing temperature, or in a case where the fluidizing temperature is higher than the foaming temperature, the thermoplastic material is in a solid powder state when the foaming agent (for example, pearl powder) is foamed and the thermoplastic material does not interfere with foaming, temperature is further increased, and then the thermoplastic material is fluidized, and viscosity can be exhibited.

Next, a second embodiment of the present invention will be described. A hollow glass and a method of manufacturing a hollow glass according to the second embodiment are the same as those in the first embodiment, and parts of configurations and methods are different from those in the first embodiment. Hereinafter, differences from the first embodiment will be described.

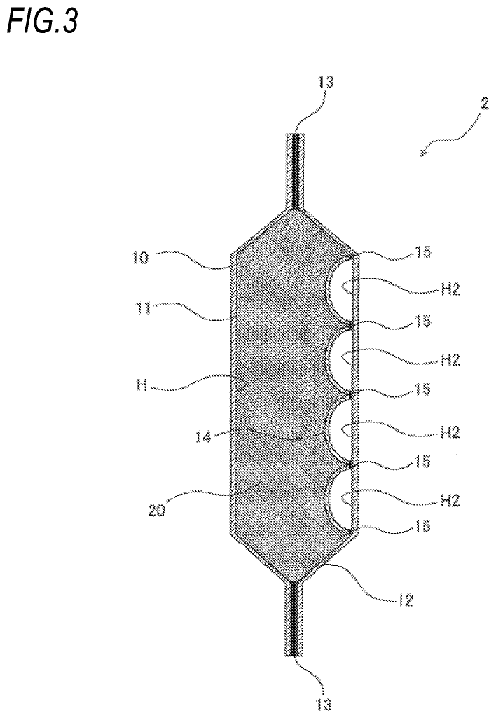

FIG. 3 is a cross-sectional view showing an example of a vacuum heat insulation panel (vacuum heat insulator) 2 according to the second embodiment. As shown in FIG. 3, the vacuum heat insulation panel 2 according to the second embodiment is similar to the vacuum heat insulation panel according to the first embodiment in that two metal plates 11 and 12 are sealed at outer peripheries via the joining portion 13, and the vacuum heat insulation panel 2 according to the second embodiment is different from the vacuum heat insulation panel according to the first embodiment in that the vacuum heat insulation panel 2 further includes a third metal plate 14.

The third metal plate 14 is integrated with an inner portion of the metal plate 12 via joining portions 15. The joining portions 15 are formed at a plurality of spots along a longitudinal direction of the vacuum heat insulation panel 2. The joining portions 15 are also formed by seam welding or diffusion joining.

Further, the third metal plate 14 has, for example, a wave shape in a cross-sectional view, and second hollow portions H2 are formed between the third metal plate 14 and the metal plate 12. The second hollow portions H2 may be evacuated, may be filled with a gas, and the like. Further, a latent heat storage material or the like may be put into the second hollow portion H2.

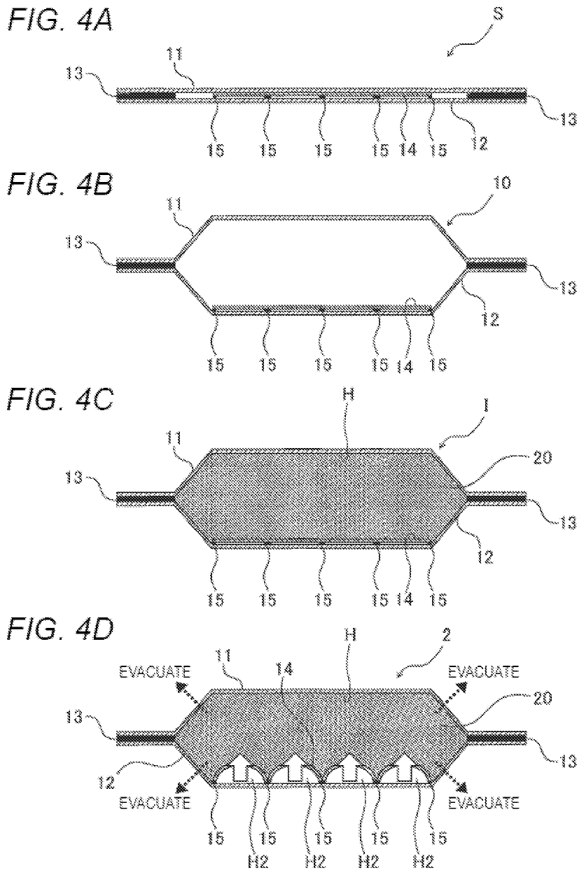

FIGS. 4A to 4D are step diagrams showing a method of manufacturing the vacuum heat insulation panel 2 according to the second embodiment, FIG. 4A shows a preparation step, FIG. 4B shows a hollow body manufacturing step, FIG. 4C shows a foaming agent introducing step, and FIG. 4D shows a vacuum solidification step. The coating step is omitted in FIGS. 4A to 4D.

First, in the preparation step shown in FIG. 4A, the metal plates 11, 12, and 14 are prepared, and the joining portions 13 and 15 are formed by seam welding or diffusion joining. Accordingly, a stacked body S having a flat plate shape is obtained.

Next, the hollow body 10 is manufactured in the hollow body manufacturing step shown in FIG. 4B (first step). This step is the same as that described with reference to FIG. 2B. Thereafter, an intermediate I is manufactured in the foaming agent introducing step shown in FIG. 4C. This step is the same as that described with reference to FIG. 2C.

Next, in the vacuum solidification step according to the second embodiment, argon gas or the like is fed into gaps between the metal plate 12 and the third metal plate 14. As a result, a gas pressure is applied to the gaps between the metal plates 12 and 14 to expand internal spaces, and the second hollow portions H2 shown in FIG. 4D are formed. The foam 20 is pressed by the formation of the second hollow portions H2, and the foam 20 is solidified (second step). Further, even when there is a portion where the foam 20 does not spread in the hollow portion H, the foam 20 can spread by such pressing. Then, after the foam 20 is solidified or during the solidification of the foam 20, the hollow portion H is evacuated to evacuate inner sides of the open cells (third step). After the evacuation, the hollow portions H are sealed by an appropriate method. The evacuation may be performed for the second hollow portions H2 after the second hollow portions H2 are cooled to some extent.

In this manner, according to the method of manufacturing the vacuum heat insulation panel 2 in the second embodiment, the same effects as those in the first embodiment can be obtained.

Further, according to the second embodiment, since the foam 20 in the hollow portion H is pressed and solidified by forming the second hollow portions H2, the foam 20 can further spread to every corner in the hollow portion H.

Although the present invention has been described above based on the embodiments, the present invention is not limited to the above embodiments, and modifications may be made without departing from the spirit of the present invention, and techniques of the embodiments and publicly-known or well-known techniques may be combined as appropriate within the scope of the present invention.

For example, the hollow body 10 includes a plurality of metal plates 11, 12, and 14 in the embodiments described above, but the present invention is not limited thereto, and the hollow body 10 may be formed of another material such as a glass material as long as the hollow body 10 has heat resistance. Furthermore, the number of the metal plates 11, 12, and 14 is not limited to two or three, and may be four or more.

Furthermore, the hollow body 10 is manufactured by applying a gas pressure to the plurality of metal plates 11, 12, and 14 in the embodiments described above, but the present invention is not limited thereto, and the hollow body 10 may be formed by, for example, combining deep drawn metal plates.

In addition, an example in which any one of the three methods for solidifying the foam 20 is performed has been described in the embodiments described above, but the present invention is not limited thereto, and two or more methods may be performed.

The present invention is not limited to a case where the foaming agent is introduced to the hollow portion H in a state in which the foaming agent is in a fully unfoamed state, and the foaming agent may be introduced into the hollow portion H in a state in which a part of the foaming agent is in a foamed state, or the foaming agent may be introduced into the hollow portion H in a state in which the foaming agent is the fully foamed foam 20.

Although various embodiments have been described above with reference to the drawings, it is needless to say that the present invention is not limited to these examples. It will be apparent to those skilled in the art that various changes and modifications may be conceived within the scope of the claims. It is also understood that the various changes and modifications belong to the technical scope of the present invention. In addition, respective constituent elements in the embodiments described above may be freely combined without departing from the gist of the invention.

According to the embodiments, it is possible to provide a method of manufacturing a vacuum heat insulator and a vacuum heat insulator that can ensure fire resistance, shape stability, and a heat insulation property. The embodiments having such effects are useful for a method of manufacturing a vacuum heat insulator and a vacuum heat insulator.

What is claimed is:

1. A method of manufacturing a vacuum heat insulator comprising:
preparing a hollow body that has heat resistance equal to or higher than a level to withstand a flame of 781° C. for 20 minutes and that has a hollow portion in the hollow body;
introducing, into the hollow portion of the hollow body, an inorganic foaming agent that has the heat resistance and foaming the foaming agent to form a foam having open cells, or introducing an inorganic foam having the heat resistance and open cells, and then solidifying the foam; and
evacuating the hollow portion after the foam is solidified or during the solidification of the foam.

2. The method of manufacturing a vacuum heat insulator according to claim 1,
wherein the hollow body having the hollow portion is manufactured and prepared by processing a plurality of stacked metal plates having a plate thickness of 0.1 mm or more and 2.0 mm or less.

3. The method of manufacturing a vacuum heat insulator according to claim 2,
wherein the hollow body having the hollow portion is manufactured and prepared by processing the plurality of metal plates in a high temperature environment in which temperature is equal to or higher than a temperature that is lower than a foaming temperature of at least a part of the foaming agent by 200° C.; and
wherein the foaming agent is introduced into the hollow portion while the high temperature environment is maintained.

4. The method of manufacturing a vacuum heat insulator according to claim 2,
wherein the foaming agent for forming open cells at a time of foaming or the foam having open cells and a fusing material that is fluidized at a temperature equal to or higher than a heat resistant temperature of 781° C. are introduced, and
wherein the hollow body having the hollow portion is manufactured and prepared by processing the plurality of metal plates in a high temperature environment in which temperature is equal to or higher than a temperature that is lower than a fluidizing temperature of the fusing material by 200° C.

5. The method of manufacturing a vacuum heat insulator according to claim 1,
wherein an external force is applied to the foam to solidify the foam.

6. The method of manufacturing a vacuum heat insulator according to claim 1,
wherein a mixture of a foaming agent for forming open cells at a time of foaming and a foaming agent for forming closed cell at a time of foaming is introduced into the hollow portion of the hollow body.

7. The method of manufacturing a vacuum heat insulator according to claim 1,
wherein an adhesive that is not foamed and has heat resistance at a foaming temperature of the foaming agent is introduced together with the foaming agent.

8. The method of manufacturing a vacuum heat insulator according to claim 1, further comprising:
applying a surface treatment material that is melted at a melting temperature equal to or higher than a heat resistant temperature of 781° C. to at least a part of an outer surface of the hollow body that maintains the melting temperature after the foam is solidified.

9. The method of manufacturing a vacuum heat insulator according to claim 1,
wherein the hollow portion is evacuated when the foaming agent or the foam is introduced.

10. A vacuum heat insulator comprising:
a hollow body that has heat resistance equal to or higher than heat resistance to withstand a flame of 781° C. for 20 minutes and that has a hollow portion formed in the hollow body; and
an inorganic foam that spreads in the hollow portion of the hollow body, is formed with open cells, is foamed and solidified, and has the heat resistance,
wherein the hollow portion is evacuated.
